(19) United States
(12) Patent Application Publication
(10) Pub. No.: US 2002/0120470 A1
(43) Pub. Date: Aug. 29, 2002

(54) Portable personal and medical information system and method for making and using system

(76) Inventor: Eugene Trice SR., Kenner, LA (US)

Correspondence Address: Len R. Brignac, Attorney at Law, King, LeBlanc & Bland, LLP, 201 St. Charles Avenue, Suite 3800, New Orleans, LA, 70170, US

(21) Appl. No.: 09/791,939

(22) Filed: Feb. 23, 2001

(51) Int. Cl. G06F 17/60

(52) U.S. Cl. 705/3

(57) ABSTRACT

The system of the invention provides a credit card size CD containing eye readable and machine readable personal and medical data. The eye readable information on the CD provides a medical care provider with an overview of a cardholder's medical condition and emergency and insurance contact information. The machine readable information encoded on the CD provides significantly more additional information about the individual than the eye readable information. The CD is encoded with programs to receive, organize, store, protect, transmit and display the machine readable data. The CD is approximately the size of a standard credit card and can be read in any standard personal computer CD reader such as a CD-ROM.

### BACKGROUND OF THE INVENTION

1. Field of the Invention

The present invention relates to a system for receiving, organizing, storing, protecting, transmitting and displaying customized personal and medical data and methods for making and using such a system.

2. Description of the Related Art

Systems and devices exist that store an individual's personal and medical information. Most systems primarily serve the purpose of identification cards, and typically consist of paper or plastic identification cards. Additional existing methods of storing and displaying medical information are by means of microfilm, magnetic strips or small microprocessor chips attached to the card surfaces. These formats are extremely limited in the amount and type of data they can store and provide limited accessibility to healthcare providers.

U.S. Pat. No. 4,632,428 discloses an eye and machine readable medical data, identification and health insurance card having two “leaves”, each of which has two faces upon which data may appear. The leaves, which are card-like members, are interconnected by a self-hinge, and may be folded with respect to each other or made to lie flat. The data includes eye-readable material on the card, as well as on a microfilm strip associated with the card, and also machine readable indicia such as the bearer's medical history, including, if so desired, an electro-cardiogram.

U.S. Pat. No. 5,195,783 discloses identification devices, which embodiments include a shoelace near the center of the card to which is affixed a flexible strip, made from textile, plastic, or other suitable material, that is adapted to be wrapped about the shoelace and retained in that position. Desired information, such as name, address, telephone number, blood type, medical facts of special concern, or the like, may appear on the surface of the strip which is to be concealed by the strip having been overlaid by itself as it is wrapped about the shoelace. The strip, so marked and so positioned, may be surrounded by a protective cover material, such as a short, tubular segment of clear plastic, to protect the strip while keeping the distinguishing indicia visible. Such protective cover and/or the surface of the strip which is exposed when the strip is so wrapped may include distinguishing indicia to notify interested persons, such as police, medical workers, and the like, of the existence of the enclosed information. Thereby, the identification of a lost child, or information relevant to treating a person in medical emergency may be identified as being available and made easily accessible when needed, while being concealed until then.

U.S. Pat. No. 4,236,332 discloses a medical record card wherein a supporting card contains a microfilm portion having indicia visible to the human eye coded for particular chronic conditions which affect emergency treatment and having indicia visible by use of a microfilm reader which detail the medical history and identification data of the patient. The supporting card contains the code for the indicia which alert medical personnel to chronic conditions and, in addition, contains some important identification data about the patent and about the type and use of the medical record card.

U.S. Pat. No. 5,215,334 discloses an emergency medical card which includes a first location for displaying a reduced-sized medical data transparency with a detachable lens element for separation from the card to view the medical data contained on the transparency. In a first embodiment, a hinge member secures the periphery of a first card with the periphery of a reduced-size lens card, with the hinge permitting the lens card to be bent back adjacent to the first card so that its profile remains that of a typical credit card. In a second embodiment, the lens is secured by a perforation within the profile of the same card.

### SUMMARY OF THE INVENTION

The present invention provides eye readable and machine readable personal and medical data on a CD-R/RW. The eye readable information on the CD-R/RW provides a medical care provider with an overview of a cardholder's medical condition and emergency and insurance contact information. The machine readable information encoded on the CD-R/RW provides significantly more additional information about the individual than the eye readable information. The CD-R/RW is encoded with programs to receive, organize, store, protect, transmit and display the machine readable data. The CD-R/RW is approximately the size of a standard credit card and can be read in any standard personal computer CD-R/RW reader such as a CD-ROM. The CD-R/RW can be customized by a user with the use of a standard size CD containing profile generating software.

### BRIEF DESCRIPTION OF THE DRAWINGS

Objects and features of the present invention will become apparent from the following detailed description considered in connection with the accompanying drawings that disclose an embodiment of the present invention. It should be understood, however, that the drawings are designed for the purpose of illustration only and not as a definition of the limits of the invention.

FIG. 1 is a perspective view of an embodiment of the credit card sized CD-R/RW card of this invention;

FIG. 2 is a schematic block diagram of the system according to the invention for generating the card of the invention;

FIG. 3 is a schematic block diagram of the system according to the invention illustrating the functionality and operation process;

FIG. 4 is a perspective view of an embodiment of the standard size CD of this invention.

### DESCRIPTION OF THE PREFERRED EMBODIMENTS

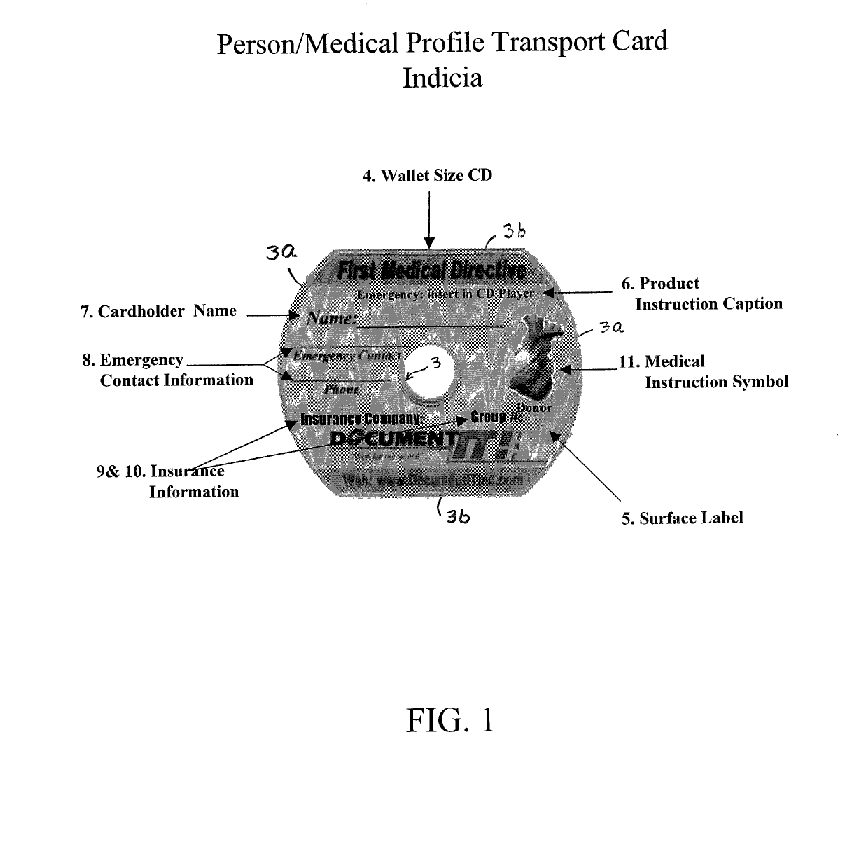

The portable personal and medical information system shown in FIGS. 1-4 includes a wallet size or credit card size compact disc (CD-R/RW) card generally indicated by the numeral 4 in FIG. 1 that is suitable for receiving and storing inputted data. The technology utilized in manufacturing a credit card size CD-R/RW is well known in the art and is commonly referred to as business card CD technology. The most available type of business card CD from which card 4 is constructed is sometimes referred to as “CD-R” which can have data permanently written or burned on the CD by a laser contained in known CD writer device. Alternatively, the CD is referred to as “CD-RW” or “CD-R/RW” with “RW” being an abbreviation for rewritable, and this type of CD can be written, erased and re-written with electronic data by a CD writer device. As shown in FIG. 1, CD-R/RW card 4 has a circular opening generally indicated by the numeral 3 in the center thereof for receipt of a drive spindle of a conventional CD-ROM drive of a conventional home or personal computer. Preferably, CD-R/RW card 4 has arcuate opposite outer edges 3a-3a which enable CD-R/RW card 4 to be centered in the smaller inner cylindrical depression in a conventional CD-ROM drive well known to those skilled in the art which is concentric with the larger cylindrical depression for receipt of a standard CD, and CD-R/RW card 4 has parallel linear edges 3b-3b which enable CD-R/RW card 4 to be easily inserted into a conventional credit card holder in a wallet, purse, or the like.

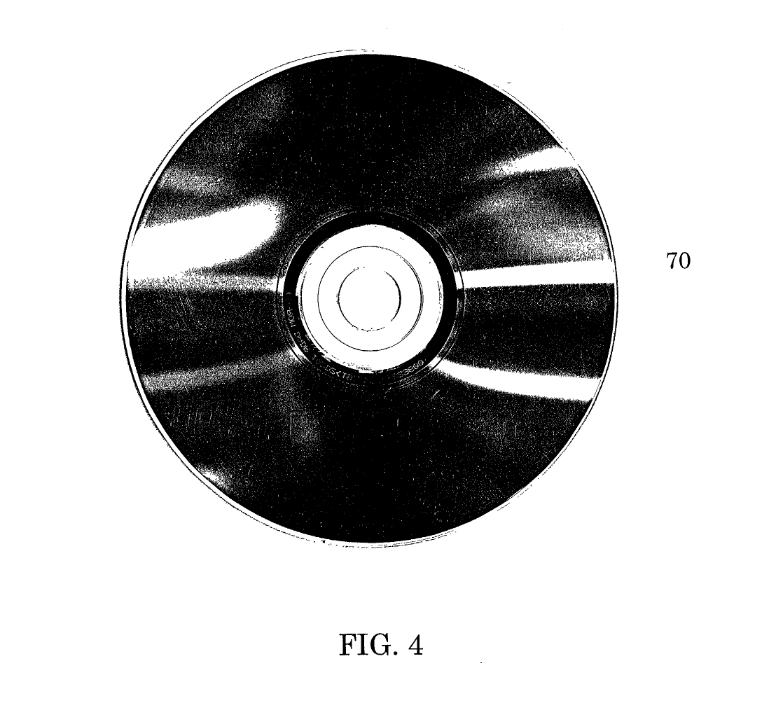

To allow a cardholder to enter their personal data and medical information, the personal/medical profile identification system of the invention also includes a standard size CD 70 as shown in FIG. 4. This standard size CD 70 includes a known initial set-up software package that can be installed and set up by the cardholder. The user of the system of the invention would need a general-purpose computer having a scanner or CD reading capability such as a CD-ROM reader and preferably an internet connection.

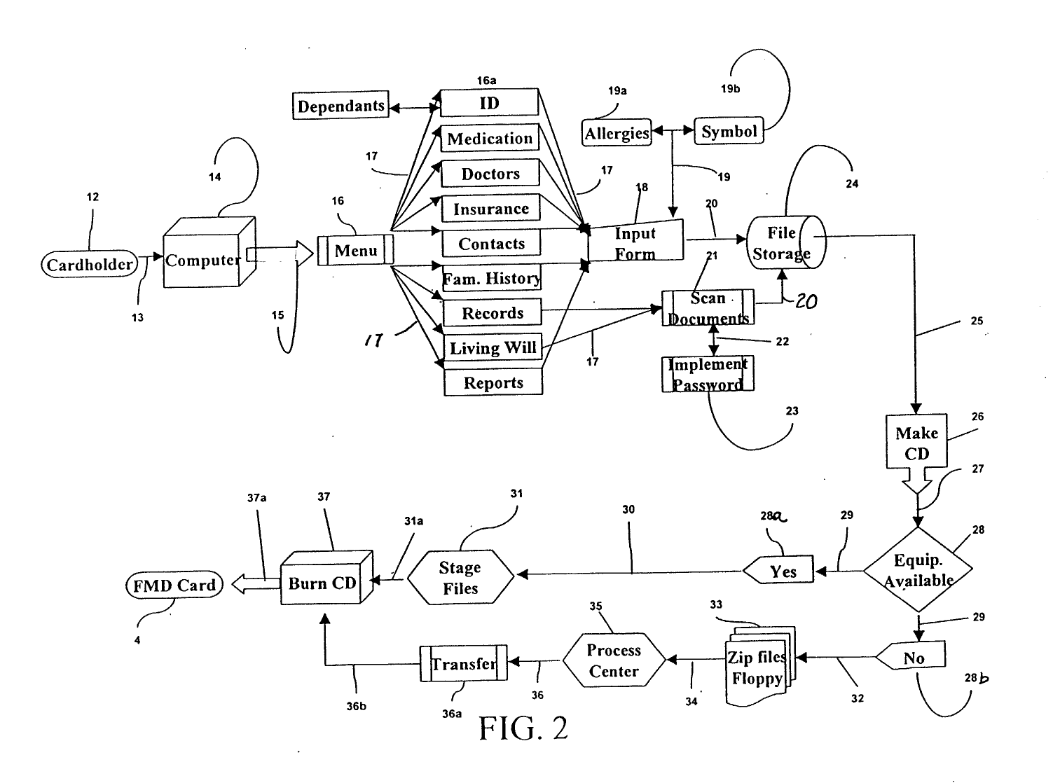

The CD-R/RW card 4 of the invention has eye readable information 6, 7, 8, 9, 10 and 11 preferably imprinted on a surface paper label 5 as shown in FIG. 1 relating to the use of CD-R/RW card 4 which is customized and generated as illustrated in FIG. 2 for the individual cardholder. Surface or topside label 5 preferably has an adhesive stick-on backing which adheres to the surface or topside of CD-R/RW card 4. However, if desired, the eye readable information can be directly printed on the surface of CD-R/RW card 4. The customized eye readable data 6, 7, 8, 9, and 10 provides essential medical information to emergency medical personnel at times when the cardholder may not be capable of conversation.

As shown in FIG. 1, the eye readable information on CD-R/RW card 4 preferably includes at location 6 instructions for the use of CD-R/RW card 4 to emergency personnel to place the CD-R/RW card 4 in a CD player thereby enabling the emergency personnel to conclude that CD-R/RW card 4 is a CD, the cardholder's name at location 7, emergency contact information at location 8, insurance information such as the cardholder's insurance company and policy and group number at locations 9 and 10, and medical symbols or icons at location 11 customized to the cardholder's medical condition, such as symbols relating to diabetes, heart condition, allergies and other similar commonly known symbols or icons. If desired, other selected relevant information of the user such as social security number, blood type, allergies, organ donor instructions, and the like may be included on CD-R/RW card 4 as eye readable information.

As shown in FIG. 2, the data encoded on CD-R/RW card 4 can be customized by the cardholder-user 12 by inserting 13 a standard size CD 70 having encoded selected software programs, into the CD drive of a conventional CD reader such as a CD-ROM of a conventional home or personal computer 14 and inputting the desired personal and medical information utilizing the computer keyboard and other computer input devices. The standard size CD 70 is supplied to the cardholder-user by the provider of the system of the invention, and the selected programs encoded on standard size CD 70 include a conventional type of software program well known in the art that self starts the standard size CD 70 when placed in the CD-ROM of computer 14 and initiates a medical profile generator software program 15 resident in computer 14. After startup of CD card 70, the conventional personal or home computer 14 receives the conventional profile generating software program 15 that enables the system of the invention to generate a menu 16 displayed on a conventional monitor connected to computer 14.

As further shown in FIG. 2, menu 16 of profile generating software program 15 via links 17 prompts the user-cardholder to enter specific data shown in the module boxes 16a aligned vertically in FIG. 2 regarding the cardholder's personal and medical data, such as the cardholder's name, address and telephone number, Medication, Doctors, Insurance, Insurance claims and related information, Contacts in the event of an emergency, Family History and medical history, Records, Living Will, Reports, and any other desired information which are displayed on a conventional monitor of computer 14. Additionally, information module boxes 16a access via links 17 electronic data recording form 18 and scanner 21 to prompt the user-cardholder to enter and record data, text and images, such as living wills, x-rays and medical records, for subsequent encoding onto CD-R/RW card 4 by the user-cardholder as additional data. The user-cardholder is prompted by call 22 to information module 23 to select and enter a password to protect the data from unauthorized access for subsequent inputting to CD-R/RW card 4. The user-cardholder is also prompted by call 19 to information modules 19a and 19b to enter eye-readable information concerning allergies and medical alert symbols for subsequent encoding to CD-R/RW card 4.

The data entered above is received, organized and stored in data storage files 24 via links 20. The data is then compressed and encrypted by conventional software programs well known in the art and readily available to skilled programmers. CD-R/RW card 4 also has encoded thereon a conventional, commercially available viewer software program well known in the art that retrieves, displays (zooms, rotates) and prints the data inputted by the user, and optionally a surface or topside label 5 for placement on CD-R/RW card 4. Preferably the label 5 is supplied to the user by the provider of the system of the invention in blank form to be filled out by the cardholder by pen or typewriter. A sheet of peel-off conventional medical instruction symbols or icons 11 having an adhesive on the rear side thereof may also be supplied to the cardholder by the provider of the system of the invention, and the cardholder may place the appropriate symbol or icon 11 corresponding to the condition of the cardholder on the label 5 at the location indicated in FIG. 1. CD-R/RW card 4 also has conventional, commercially available internet communication software well known in the art encoded thereon to transmit data encrypted thereon via the internet to any desired internet address, website or URL (uniform resource locator).

Two alternatives are shown in FIG. 2 to provide for encoding information in file storage 24 via link 25 to make CD-R/RW card 4. A request for CD-R/RW cards 4 is initiated with a call from storage file 24 via link 25 to Make CD module 26, which initiates calls via links 27 to Equipment Available module 28 which determines if computer 14 has equipment required to record a CD (commonly referred to as burning), such equipment being commonly referred to as a CD burner 37. If the computer 14 is equipped with a CD burner 37, a CD-R/RW card 4 supplied by the provider of the system to the user is placed 31a in the user's computer CD burner 37, data from storage file 24 travels through link 25, Make CD module 26, link 27, Equipment Available module 28, link 29, Yes module 28a, link 30, Stage Files module 31, to CD burner 37 where the data from storage file 24 is encoded or burned 37a onto the underside of CD-R/RW card 4 having the programming and data described above encoded thereon to produce CD-R/RW card 4. The Stage Files module 31 receives all files forwarded thereto through link 30, consolidates and re-organizes the files, and encrypts the files prior to forwarding the files via link 31a to CD burner 37. If the computer 14 is not equipped with a CD burner, data from storage file 24 travels through link 25, Make CD module 26, link 27, Equipment Available module 28, link 29, No module 28b, link 32, Zip files Floppy 33, Internet link 34, Process Center module 35, link 36, Transfer module 36a, and link 36b to CD burner 37 where the data from storage file 24 is encoded or burned 37a onto a CD-R/RW having the programming and data described above encoded thereon to produce CD-R/RW card 4. Transfer module 36a unzips the zipped files received via link 36, extracts data, and checks or validates the unzipped files to ascertain if all files are complete prior to forwarding the files via link 31 to CD burner 37. Alternatively, the user's identification data can be inputted by a third party such as the supplier of the system and the encoded personalized CD-R/RW card 4 can be forwarded to the user by traditional delivery means such as mailing.

It is preferred that the data ultimately be forwarded to a central processing facility or Process Center 35 to enable duplicate replacement CD-R/RW cards 4 to be generated and to enable the cardholder's health care providers to contact central processing facility or Process Center 35 to obtain medical information regarding the cardholder and, if necessary, obtain the appropriate password for the health care provider to access CD-R/RW card 4.

Connection or link 34 to process center 35, or an internet website and/or host computer database can be by any suitable connection, such as, for example, a hardware network, a telephone network, an on-line computer network using modems. Other suitable methods for transmitting and submitting the user-cardholder data for making a customized CD-R/RW card 4, could be by manual data entry into the database through internet connection or by hard printed copy faxed or otherwise transmitted to process center 35. Alternatively, the data inputted by the user of the CD-R/RW card 4 can be transmitted to zip file floppy disc 33 for shipping to the process center 35 for manufacturing customized CD-R/RW card 4.

After receipt of the data, the process center 35 generates the CD-R/RW card 4 relating to the particular individual. The process center 35 can alternatively emboss the eye readable information directly on the CD-R/RW card 4 or the eye readable information can be printed on a suitable sized label and affixed to surface or topside of the CD-R/RW card 4 by an appropriate adhesive.

CD-R/RW card 4 is then forwarded 37a to the cardholder by the provider of the system of the invention. The cardholder can easily carry at all times the credit card size CD-R/RW card 4 in a purse, wallet or the like, and the CD-R/RW card 4 can be accessed by any conventional personal computer having a CD-ROM reader by insertion of CD-R/RW card 4 into the CD-ROM.

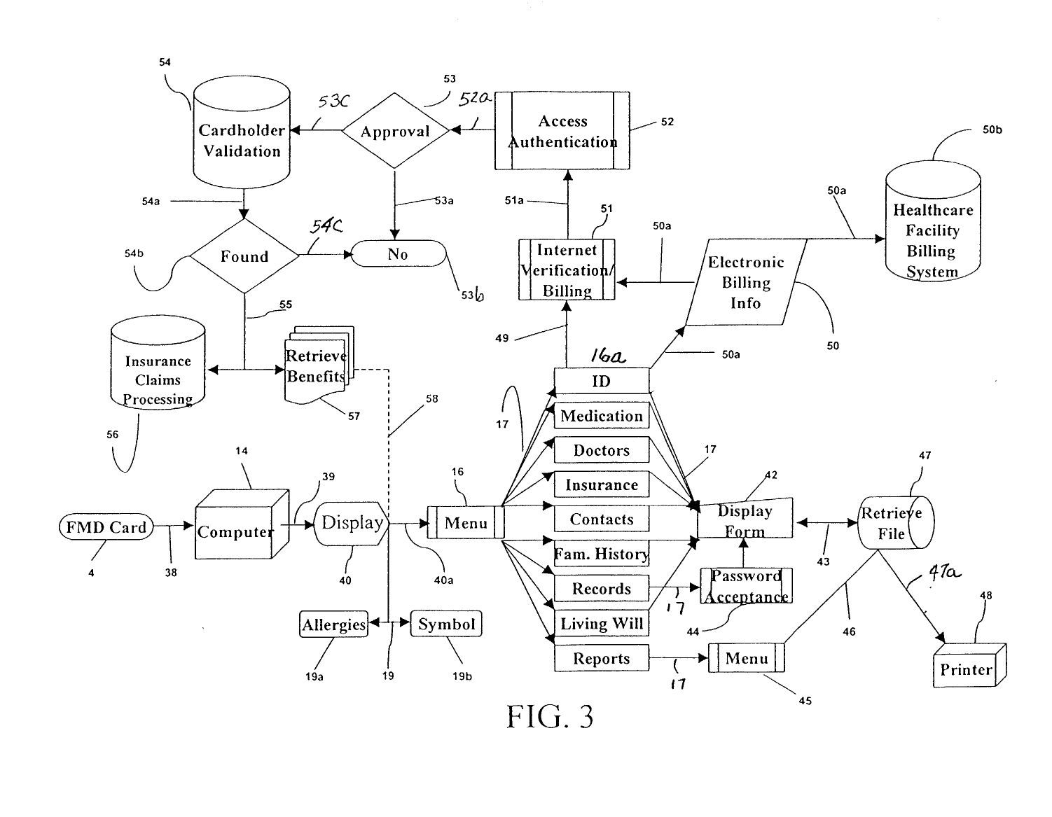

Referring to FIG. 3, in the event of a medical emergency suffered by the cardholder, or on other occasions when the cardholder presents the CD-R/RW card 4 to a health care provider, the health care provider can obtain personal and medical profile information on an incoherent cardholder by visually reading the eye-readable data and indicia located on the face of CD-R/RW card 4, or, by using the health care provider's own computer 14 equipped with a CD-ROM reader, the health care provider can access the user's medical information burned on the underside of CD-R/RW card 4 to assist in health care treatment by inserting CD-R/RW card 4 as indicated at 38 into their CD-ROM reader. Conventional commercially available software in computer 14 self-starts and displays on monitor or display 40 through connection 39 the cardholder's electronically recorded information from CD-R/RW card 4. Along with the cardholder's name and blood-type, automatic calls 19 are made to display allergies 19a and to display medical symbols or icons 19b, and call 40a is made to menu 16 which displays the cardholder's health care data through connections 17 into module boxes 16a shown vertically aligned in FIG. 3 and include such items as ID (identification), Medication, Doctors, Insurance, Contacts, Family History, Records, Living Will, Reports and other suitable categories. All the medical data is displayed on Display Form 42 that was retrieved through connection 43 from the Retrieve File 47 from CD-R/RW card 4 can be accessed by the health care provider and viewed on Display Form 42. Reports can be printed by printer 48 from the secondary report menu 45 which calls stored Retrieve Files 47 through connection 46, and forwards the report data to printer 48 through connection 47a.

Accessing the card holder patient billing record and/or insurance claim form occurs by selecting a command on the identification display form 42. Specific information is passed through a series of calls 43 to Retrieve Files 47 back to Display Form 42, and through connections 17 and 50a to Electronic Billing Info 50 and through connection 50a to the health care provider's Healthcare Facility Billing System 50b.

Electronic verification of the cardholder's insurance coverage and processing health claims over the Internet occurs by selecting a command on the identification Display Form 42 which initiates calls through connections 49 to Internet Verification Billing module 51 provided at the website or URL of the cardholder's insurance company, connection 51a to Access Authentication module 52, connection 52a to Approval module 53, through connection 53a to No module 53b if access is not approved, through connection 53c to Cardholder Validation module 54 if access is approved, through connection 54a to Found module 54b, if no information is found through connection 54c to No module 53b, if information is found through connection 55 to Insurance claims Processing module 56 and to Verify and Retrieve Benefits module 57, and through connection 58 to Display 40 to display insurance benefits information available to the cardholder found in the internet verification database and to submit insurance claim form.

Thus, by use of the internet or by direct connect 49 to a host computer database 51, the user's insurance coverage and benefits can be verified 52 quickly by contacting a pre-arranged website or maintained by the user's health care insurer. The information encoded on the CD-R/RW card 4 in machine readable format can assist the healthcare provider in not only treatment, but also claims submission, billing matters 50-50b, insurance verification 51, insurance claims processing 56 and other administrative matters.

The system can include an internet access site for providing the user with the ability to access many options and links to other internet sites that are associated with the system. Once connected to the internet access site, the user or third party medical caretaker can access the user's insurance information, submit claims forms, initiate billing records and admit information.

The password and security features prevent unauthorized access to the records can be entered at any level of data inputted to CD-R/RW card 4 as desired by the cardholder. The cardholder may enter the password immediately after the user or healthcare provider accesses the identification or ID module, or the ID and Contacts module, thereby preventing access to other personal medical data which the cardholder wishes to keep confidential. Furthermore, the insurance company of the cardholder may be provided with the cardholder's password to enable the healthcare provider or emergency personnel to access machine readable information on CD-R/RW card 4 which the cardholder wishes to keep confidential when the cardholder is incoherent, or the cardholder may supply the healthcare provider with the password if the cardholder is coherent.

Periodically, as needed, the user can update or change the data included on CD-R/RW card 4 at the user's own personal computer, and CD-R/RW card 4 can be rewritten if the cardholder's personal computer has the capability. Alternatively, the user can contact Process Center 35 or supplier by internet or other means to provide the updated information to write a replacement CD-R/RW card 4. The type of information and data included on CD-R/RW card 4 is not necessarily limited can include automobile insurance, driver's license information, personal or business documents, the user's dependents and family's medical data history, insurance benefits and contact information, insurance claim form data, personal and medical family history, photographs, medications, allergies, race, gender, birth date, Social Security number, height, weight, blood type, address, emergency contact information, physicians, physician's contact information, insurance companies, employer, medications, etc. The amount and detail of the information that can be contained on CD-R/RW card 4 is limited only by the user's determination and the capacity of the CD-R/RW card 4.

As explained above, CD-R/RW card 4 contains security features such as a password system by which an individual user creates his own security password that limits access to confidential data. Any other suitable known method of preventing unauthorized access to the stored user information may also be incorporated into the system.

Although the preferred embodiments of the invention have been described in detail above, it should be understood that the invention is in no sense limited thereby, and its scope is to be determined by that of the following claims:

What is claimed is:

1. A portable personal data and medical data system comprising:
a credit card sized CD-R/RW card having customized eye readable personal and medical data and having machine readable personal and medical data encoded on said CD-R/RW;
said CD-R/RW card having a viewer software program encoded on said CD-R/RW programmed to operate with a personal computer to retrieve, display, transmit and print the machine readable personal and medical data inputted into the personal computer;
said CD-R/RW card having a security software program encoded thereon that protects selected portions of said machine readable personal and medical data encoded on the CD-R/RW card from unauthorized or accidental access.

2. The portable personal data and medical data system of claim 1 further comprising:
a standard size CD having a profile generator software program encoded on said standard size CD programmed to operate with the personal computer to receive, organize and store said personal and medical data inputted by an individual user;

3. The portable personal data and medical data system of claim 2 wherein said CD-R/RW card has internet communication software encoded thereon which enables the user of said CD-R/RW card or a third party health provider to transmit by a internet connection some or all of said machine readable personal and medical data to an internet website or a URL.

4. The portable personal data and medical data system of claim 3 wherein said profile generator software program enables encoding and storage of scanned images on said CD-R/RW card.

5. The portable personal data and medical data system of claim 4 wherein said machine readable personal data encoded on said CD-R/RW card includes the cardholder's name and address, medical insurance company identity, cardholder's insurance benefits and insurance claim processing data.

6. The portable personal data and medical data system of claim 5 wherein said eye readable information includes emergency medical information of the user and includes such data as the cardholder's name, address, insurance company, medical icons, allergies, and emergency contact information.

7. The portable personal data and medical data system of claim 1 wherein said CD-R/RW card has an opening in the center thereof for receipt of a CD reader drive spindle.

8. The portable personal data and medical data system of claim 7 wherein said CD-R/RW card is generally rectangular in shape and has four edges.

9. The portable personal data and medical data system of claim 8 wherein two opposing edges of said four edges of said CD-R/RW card are linear and parallel and two opposing edges of said edges are arcuate.

10. The portable personal data and medical data system of claim 9 wherein said eye readable information is printed on a label attached to the surface of said CD-R/RW card.

11. A portable personal data and medical data system comprising:
a. a credit card size CD-R/RW card having eye readable personal and medical data and having machine readable personal and medical data encoded thereon, said eye readable and machine readable personal and medical data encoded on a said CD card supplied by and customized to an individual cardholder,
b. a CD card having a profile generator software program encoded thereon which operates with a personal computer having a CD reader and burner to receive, store and update the personal and medical data inputted by the cardholder for encoding on said CD-R/RW card by use of a CD burner,
c. said CD-R/RW card having a viewer software program encoded thereon that operates with said personal computer to organize, retrieve, display and print the machine readable personal and medical data inputted into the personal computer by the user,
d. said CD-R/RW card having a software program encoded thereon that compresses, encrypts and enables transmittal of selected portions of the machine readable data to a floppy disc or through the internet, and
e. said CD-R/RW card having a security software program that protects the machine readable personal and medical data encoded on said CD-R/RW card from unauthorized or accidental access.

12. A method for making a customized personal and medical data system comprising the steps of.
a. loading a standard size CD on the CD reader of a personal computer;
b. inputting a cardholder's personal and medical data by use of a modules contained in a profile generator program software program encoded on said CD;
c. assigning a password to protect said data from unauthorized access;
d. compressing said data storage files;
e. encrypting said data storage files; and
f. transmitting said data storage files to a CD-R/RW card by use of a encoding means.

13. The method of claim 12 further comprising the steps of activating a document viewer through which previously inputted data is retrieved, displayed and printed.

14. The method of claim 13 further comprising the step of transmitting selected portions of said data storage files by internet connection.

15. The method of claim 14 further comprising the steps printing eye readable information on said CD-R/RW card.

16. The method of claim 15, further comprising the step of accessing said CD-R/RW card's machine readable data on a third party medical care provider's personal computer.

17. A method for making customized personal and medical data system comprising steps of:
a. loading a CD into a personal computer;
b. initiating a profile generator software program encoded on said CD;
c. prompting the user to provide personal and medical information and data in specific categories;
d. storing the personal and medical data in a data storage file;
e. compressing and encrypting said data storage file;
f. transmitting said compressed and encrypted data file to a central processing facility;
g. encoding the customized personal and medical data onto a credit card size CD-R/RW in machine readable format; and
h. writing customized eye readable information on said CD-R/RW card.

18. The method of claim 18 comprising the additional step of accessing and displaying said machine readable data by a healthcare provider on a healthcare provider's personal computer.

19. The method of claim 19 comprising the additional step of transmitting selected items of said compressed and encrypted data storage files through internet communication to a health care provider's personal computer or host computer.

20. The method of claim 18 comprising the additional step of decompressing and de-crypting the data storage file for access and display by the healthcare provider utilizing said medical data to provide health care services to the user.

21. The method of claim 18 comprising the additional steps of:
a. using said data on said CD-R/RW card to assist in healthcare provider billing;
b. using said data on said CD-R/RW card to assist in processing insurance claims and coverage determinations;
